(19) United States
(12) Patent Application Publication
(10) Pub. No.: US 2020/0113154 A1
(43) Pub. Date: Apr. 16, 2020

(54) CAT BRUSH HAVING INTEGRAL PENETRTION GUIDE

(71) Applicant: Susan Lee Grimaldi, Plainfield, VT (US)

(72) Inventor: Susan Lee Grimaldi, Plainfield, VT (US)

(21) Appl. No.: 16/157,854

(22) Filed: Oct. 11, 2018

(51) Int. Cl. A01K 13/00; A46B 9/02

(52) U.S. Cl. CPC A01K 13/002; A46B 2200/1093; A46B 9/028

(57) ABSTRACT

A cat brush with a surface having adjacent spaced apart fingers intended to interfit between the hairs of a feline coat, so that the hairs can be dragged therethrough to align the hairs and remove matted fur, wherein the improvement comprises configuring the fingers such that the fingers taper from the surface to a point and are characterized by a maximum thickness (Tₘₐₓ) measured at and parallel to the surface, a maximum height (Hₘₐₓ) measured perpendicular to the surface, and a midway thickness (T_{1/2}) measured parallel to the surface at one-half the maximum height, such that: (2×Tₘₐₓ)<Hₘₐₓ<(3×Tₘₐₓ); and Tₘₐₓ≥(2×T_{1/2}); and Hₘₐₓ=2 to 5 mm.

### FIELD OF THE INVENTION

My invention relates to animal husbandry, particularly grooming devices, and provides a brush having adjacent spaced apart fingers intended to interfit between the hairs of a feline coat, so that the hairs can be dragged therethrough to align the hairs and remove matted fur.

### BACKGROUND OF THE INVENTION

Domestic cats characteristically have a smooth outer coat of long guard hairs and a fine undercoat of shorter hairs for insulation. The cat's tongue is the primary instrument that cats use for grooming. Tiny hook-like structures on the cat's tongue catch loose and dead hair, which is then swallowed. The majority of this hair passes all the way through the digestive tract with no problem, but some hair may stay in the stomach and form a hairball. Ultimately, cats will typically vomit to get rid of the hairball. However, feline hairballs sometimes cause a blockage in the stomach, intestine, or colon, and potentially dangerous and expensive surgery may be required to correct the situation.

Matting poses a special challenge for cat grooming. Mats arise when the soft fur from the undercoat is shed and gets clumped together and entangled amidst the longer outer coat. When trying to remove hair mats, pulling on the cat's fur is difficult to avoid.

Brushes are common tools for grooming hair. Referring to FIG. 1 (Prior Art), a typical brush 10 has a multiplicity of adjacent spaced apart fingers 12 that extend from a planar or curved surface 14, to which a handle 16 may be attached.

Pet grooming brushes are available in many shapes and sizes, as an Internet image search will show. I have observed that available cat brushes tend to penetrate too deeply and pull too much fur at one time, which distresses the cat and often the groomer as well.

### SUMMARY OF THE INVENTION

The short fingers of my improved cat brush interfit between the outer guard hairs of a feline coat without penetrating too far into the undercoat. Moreover, the fingers are squat and tapered to provide and promote tactile resistance as the adjacent spaced apart fingers penetrate the undercoat. The disclosed fingers thereby provide an integral penetration guide for groomers to perceive by touch and thereby determine when the fingers have penetrated deep enough into the cat's undercoat to selectively and gradually remove loose outer hairs without distressful pulling.

My improvement is to configure the fingers to have a maximum thickness (Tₘₐₓ) measured at and parallel to the surface, a maximum height (Hₘₐₓ) measured perpendicular to the surface, and a midway thickness (T_{1/2}) measured parallel to the surface at one-half the maximum height, such that: (2×Tₘₐₓ)≤Hₘₐₓ≤(3×Tₘₐₓ); and Tₘₐₓ≥(2×T_{1/2}); and Hₘₐₓ=2 to 5 mm.

The disclosed height and width dimensions foster a better grooming experience, by discouraging penetration/entanglement in favor of a gentle unraveling and recovery of individual hair strands.

### BRIEF DESCRIPTION OF THE DRAWINGS

FIG. 1 (Prior Art) shows a generic brush 10 having a multiplicity of adjacent spaced apart fingers 12 that extend from a generally planar surface 14 to which a handle 16 may be attached;

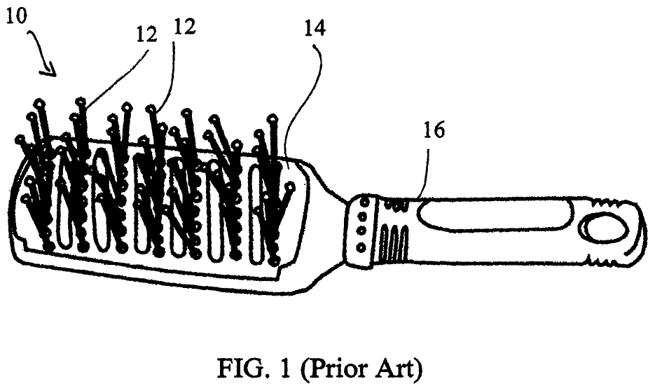

FIGS. 2A-C present schematic side views of a representative embodiment of my improved cat brush 18; and

FIG. 3 is a schematic side view of an exemplary finger 12 of my improved cat brush.

### DETAILED DESCRIPTION OF THE PREFERRED EMBODIMENT

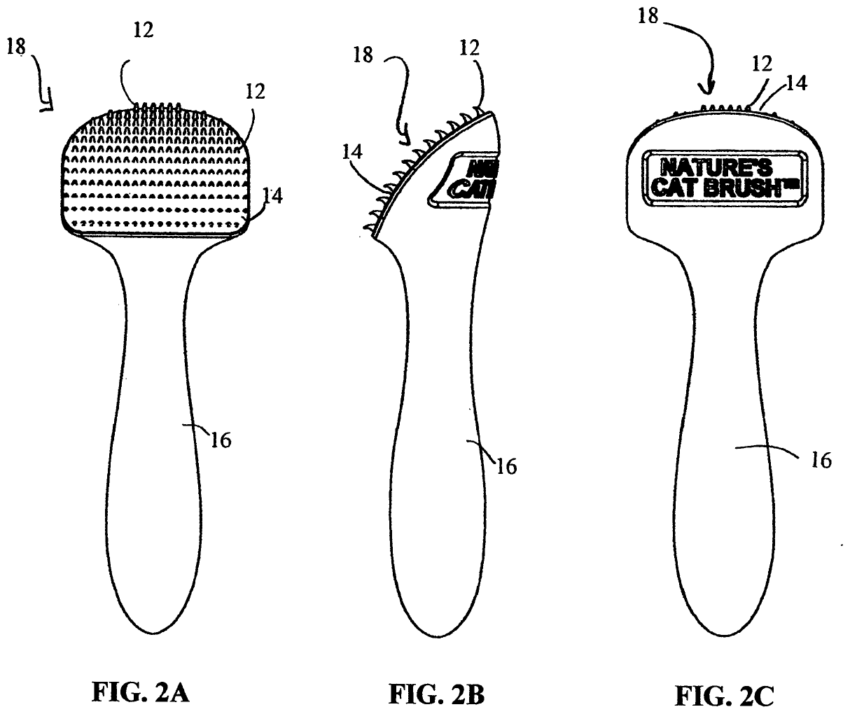

Referring to FIG. 2A, my invention provides an improved cat brush 18 having a multiplicity of short, tapered fingers 12 that extend in spaced array from a common surface 14, optionally with a handle 16 attached to the surface 14.

The surface 14 may be generally shaped as a rectangle or a roughly isosceles trapezoid, as shown in FIG. 2A. For use with domestic cats (Felis catus) the surface 14 dimensions are preferably encompassed by one or more of the following rectangles: 10×7 cm, 5×5 cm, and 4×4 cm.

The subject fingers 12 are arrayed on the surface 14 in order to interfit between and align the guard hairs of a domestic cat, with a representative lateral spacing between adjacent fingers 12 of about 1.1 mm apart as measured at the surface 14.

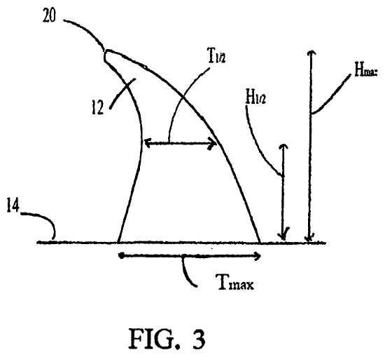

Referring to FIG. 3, each finger 12 is quite short, in terms of maximum height (Hₘₐₓ) measured perpendicular to the surface 14, in order to penetrate the undercoat without scratching the underlying skin, with a representative maximum height of about 2.8 mm above the surface 14. The maximum height (Hₘₐₓ) can range from 2 to 5 mm, preferably 2.5 to 3.5 mm, and optimally 2.75 to 3 mm.

The fingers 12 are quite squat, in terms of maximum thickness (Tₘₐₓ), as measured perpendicular to the surface 14. A representative finger 12 of 2.8 mm maximum height (Hₘₐₓ) has a maximum thickness (Tₘₐₓ) of about 1.3 mm. The following relationship is considered operable: (2×Tₘₐₓ)<Hₘₐₓ<(3×Tₘₐₓ).

The fingers 12 are also tapered in shape, that is, wider proximal the surface 14 and narrowing to a thinner distal point 20. Pursuant to the invention the narrowing taper is configured to align and compress guard hairs near the surface 14 and present the point 20 to penetrate underlying mats and undercoat. As shown here, the fingers 12 are preferably curved into a hooked shape in order to facilitate capture and removal of shed hairs.

Regardless of whether the finger 12 is straight or curved, its taper should be controlled with respect to its maximum thickness (Tₘₐₓ) and maximum height (Hₘₐₓ) as follows: Tₘₐₓ is equal to or preferably greater than (2×T_{1/2}), wherein T_{1/2} is the widest thickness of the finger 12 as measured parallel to the surface at one-half (H_{1/2}) of its maximum height (Hₘₐₓ).

Through much experimentation of size and shape of cat brush fingers, I have found that thicker finger widths prevent an effective penetration into the very fine hair of the cat undercoat. If the fingers were too long and thin they would penetrate the undercoat too far, reach the animal's skin and create an uncomfortable scratching sensation. Yet fingers too short failed to pass beyond the outer coat into the fine hair of the undercoat.

Thus my empirically determined configuration is optimized to reach the undercoat for accomplishing removal of loose hair thus preventing matting. My empirically determined shape constraints, particularly the stated relationship between T_{1/2} and Tₘₐₓ, fosters a better grooming experience, by discouraging penetration/entanglement in favor of a gentle unraveling and recovery of individual hair strands. The resulting array of adjacent spaced apart fingers provides sufficient resistance to serve as a tactile penetration or depth guide that prompts the groomer to gently locate matted hairs and avoid pulling the cat's undercoat.

My improved cat brush 18, particularly embodiments wherein Hₘₐₓ is 2.75 to 3 mm, is readily manufactured by available 3D printing processes and printers (https://en.wikipedia.org/wiki/3D printing. Accessed Oct. 11, 2018.)

While the preferred embodiment of the invention has been illustrated and described, it will be appreciated that various changes can be made therein without departing from the spirit and scope of the invention. For example, the disclosed configuration can be adapted for use with larger felines, other mammalian pets, and farm animals.

1. A cat brush comprising a surface having adjacent spaced apart fingers intended to interfit between the hairs of a feline coat, so that the hairs can be dragged therethrough to align the hairs and remove matted fur,
wherein the surface is less than 5×5 cm (2×2 inch), and
wherein the fingers taper from the surface to a point in a hook shape and are characterized by
a maximum thickness (Tₘₐₓ) measured at and parallel to the surface,
a maximum height (Hₘₐₓ) measured perpendicular to the surface, and
a midway thickness (T_{1/2}) measured parallel to the surface at one half the maximum height, wherein
(2×Tₘₐₓ)<Hₘₐₓ<(3×Tₘₐₓ),
Tₘₐₓ≥(2×T_{1/2}), and
Hₘₐₓ=2 to 5 mm (0.1×0.2 inch).

2. (canceled)

3. The cat brush of claim 1, wherein Hₘₐₓ=2.5 to 3.5 mm.

4. (canceled)

5. The cat brush of claim 1, wherein Hₘₐₓ=2.75 to 3 mm.

6. (canceled)

7. (canceled)

8. (canceled)

9. (canceled)

10. The cat brush of claim 1, wherein the fingers are spaced apart about 1.1 mm (0.04 inch) as measured at the surface.
